(19) United States
(12) Patent Application Publication
(10) Pub. No.: US 2003/0204979 A1
(43) Pub. Date: Nov. 6, 2003

(54) Illuminated message display predominantly for automobiles

(76) Inventor: Janis Blease, Parker, CO (US)

Correspondence Address: Janis Blease, 10603 East Black Forest Drive, Parker, CO, 80138, US

(21) Appl. No.: 10/138,817

(22) Filed: May 6, 2002

(51) Int. Cl. G09F 21/04

(52) U.S. Cl. 40/597; 40/593

(57) ABSTRACT

The apparatus is an internally illuminated message display, predominantly for an automobile, and is readily adaptable for any window display. The apparatus comprises of a cylindrical lightweight molded plastic housing, with an interior reflective paint or reflective material, a distal light socket and light bulb. A proximal snap on sleeve contains a slot for the insertion of a translucent disk; said disk contains various messages and/or art symbols. The sleeve has a proximal ceiling hinge connecting it to an adjustable oval transparent suction cup frame. The oval transparent suction cup attaches to the frame and spans the face of the display with the lip of the suction cup circumnavigating the outer edge of the frame. Hinged adjustment is made for attachment to an aerodynamic sloping automobile rear window, and is stabilized with a snap on rod from sleeve to suction cup frame. The gap created from adjustment between the sleeve and frame is covered with an opaque thin snap on plastic sock.

### FIELD OF THE INVENTION

This invention relates to illuminated displays for windows, more particularly circular displays for automobile rear windows, and can be adjustable to aim horizontally when installed on sloping aerodynamic automobile rear windows. The invention is extremely lightweight molded plastic that snaps together and provides instantaneous installation that is stronger, more secure, and more stabilizing.

1. Field of the Invention

Automobile signs, bumper stickers, and illuminated signs have been popular and utilized to varying degrees for novelty, advertisement, or personal expression since the birth of the automobile. Previous illuminated automobile signs have been mounted on either the interior or exterior of the automobile. Interior automobile signs have been cumbersome, impractical, intrusive, and complicated in their assembly and mounting. In addition they often block the operator's vision.

2. Description of Prior Art

An example of impractical and intrusive mounting being U.S. Pat. No. 6,178,677 by Williams, Jan. 30, 2001 having an illuminated rectangular floor mounted apparatus (FIG. 1) which would not be suitable for Suburban Utility Vehicles (SUVs) or mini vans; as these automobiles do not have rear window dashes which would support said floor mounting. The floor mounting (FIG. 2) also requires drilling holes into the rear dash, and compromising the integrity of the dash itself, for upon the removal of said apparatus, holes are left in the rear window dash.

Other examples of a disadvantage are the use of small suction cups in the attachment of the apparatus, which allows for ‘free swinging’ from lower mounting, or above hanging of said apparatus. Two examples of this being U.S. Pat. No. 5,016,145 by Singleton, May 14, 1991 (FIG. 2) and U.S. Pat. No. 5,822,900 by Armstrong, Oct. 20, 1998 (FIG. 1).

All illuminated display apparatus known to the applicant have a display face that is square, or rectangular in shape; while none have a display face that is uniquely round.

The small suction cups are impractical as they are more subject to loosing there suction through the dynamics of automobile usage. Said dynamics being the heavy weight of the apparatus, the change in temperature and barometric pressure, and the constant tugging from vibration, centrifugal force and inertia from an automobile's constant turning, starting and stopping. The back and forth swaying of the upper, or lower half of the apparatus would cause it to bump into the rear window, causing distressing noise, and actual damage to the automobile rear window and the apparatus itself. When the small suction cups fail completely, the apparatus will drop, which could cause damage to either it or the automobile.

Furthermore, the housing of existing apparatus is heavy, and complicated in its assembly, requiring tools and instruction for its assembly, operation, and use.

Applicant is unaware of any device and/or prior art as it pertains to a suction cup that uniquely frames the entire face and embodiment of the housing for any illuminated display apparatus, and radiates another designated amount beyond said frame and housing.

Prior art, as it pertains to suction cup adhesion, all contain various proximal arrangements for attachment to various apparatus. Such arrangements being: U.S. Pat. No. 5,645,254 by Ng et al., Jul. 8, 1997, having a cylindrical proximal end containing a bifurcated channel for receiving a portion of a garland. U.S. Pat. No. 5,402,974 by Williams, Apr. 4, 1995 having a cylindrical proximal holding portion which has a slit opening for reception of a wire or hook. U.S. Pat. No. 5,110,078 by Gary, May 5, 1992 having a proximal end with a socket support member. U.S. Pat. No. 1,922,900 by Plante, Aug. 15, 1933 having a suction cup with a proximal knob that supports a wire hook element. U.S. Pat. No. 1,575,789 by Phelps, Mar. 9, 1926, having a suction cup with a proximal knob that supports a bracket.

All suction cup apparatus known to the applicant, treat the suction cup as a separate entity from the apparatus; and none treat the suction cup as an integrally incorporated part of the entire apparatus.

### SUMMARY OF THE INVENTION

With respect to foregoing disadvantages inherent in known illuminated rectangular automobile displays, as described in ‘prior art’, it is the objective of the invention to provide totally unique and new improvements, overcoming all said difficulties with an innovatively circular, stronger, and better adjustable design, without visual impairment.

The device provides a form of personal expression, being the illumination of flashed messages such as, ‘thank you,” or a happy face to fellow automobile operators; or a continual illuminated message conveying patriotisms, religious or sporting affiliation, and artwork.

It is to be known that said invention is not limited in it's application to automobile rear windows, but can be modified in arrangements and components to be adaptable to all window or glass, Plexiglas, transparent plastic, and electrical systems. Phraseology, terminology, and descriptions as used in this document should not be interpreted as limiting or absolute; but should be appreciated for the conceptual and unique ideas of the present invention; insofar as the applications do not depart from the scope and spirit of said invention.

Such an example might be the use of a 120-volt system for the device to be used on other window and/or glass surfaces. Another example might be the use of the device without the adjustable hinge for specifically mini-vans or suburban utility vehicles that have flat back windows. A final example might be the use of two or more devices on one automobile back window.

1. It is the objective to provide a new and improved illuminated automobile display apparatus with a cylindrical housing and circular face which has advantages beyond the scope of its' predecessors.

2. Again it is the objective to provide a molded plastic housing, avoiding the need for assembly, and enhancing the need for a lightweight apparatus.

3. Again it is the objective to provide a simple snap on molded plastic sleeve, to avoid the need for tools, nuts and bolts, and the inherent problems associated with small multiple parts assembly.

4. Again it is the objective to provide where needed, plastic buttons and button holes for easy snap on assembly of the stabilizing bar, and sock attachments.

5. Again it is the objective to provide an all-new concept for suction cup adhesion to a smooth automobile rear window. Said transparent suction cup adhesion will no longer be a ‘hooked on’ attachment; but will frame the entire face of the housing, and radiate another designated amount beyond the frame and housing. Said suction cup will create a suction incorporating the face of the lightweight housing. This is in strength approximately eight fold stronger than the known suction cup devices in use today. Using rounded numbers, two attached suction cups with a two inch diameter would produce a vacuum surface of 6¼ square inches; whereas the new suction cup with a display area having a six inch face and a one inch lip would have a total of over fifty square inch area of suction, or approximately eight times the vacuum strength of all previous devices. This stronger newly designed use of a suction cup would solidify the entire face of the apparatus, thus eliminating all free swinging movements due to vibration, inertia, or centrifugal force. This new design would greatly minimize suction cups from being compromised.

6. Again it is the objective to provide an eight-fold enhancement of suction cup strength, while eliminating excess weight to eliminate the deleterious effects of temperature, vibration, and barometric pressure causing the failure of the suction cups.

7. Again it is the objective to provide an easy assembly, window mounted invention that would also be horizontally adjustable when mounted on a slopping aerodynamic automobile window. Said adjustment would be from horizontal to a 30 degree or more slant, thus providing usage by automobiles with aerodynamically slanted rear windows.

### BRIEF DESCRIPTION OF THE DRAWINGS

These drawings add a better perceptual understanding of the embodiment of the illuminated message display apparatus for an automobile.

FIG. 1 is a cut-away schematic of the entire embodiment.

FIG. 2 is a perspective view of how the illuminated message display apparatus might look in the rear window of an automobile.

FIG. 3 is a cut-away view showing the embodiment attached and adjusted to a slanted aerodynamic rear window of an automobile.

FIG. 4 is a front view of the embodiment.

FIG. 5 is an embodiment of the snap on opaque sock.

### DESCRIPTION OF THE PREFERRED EMBODIMENT

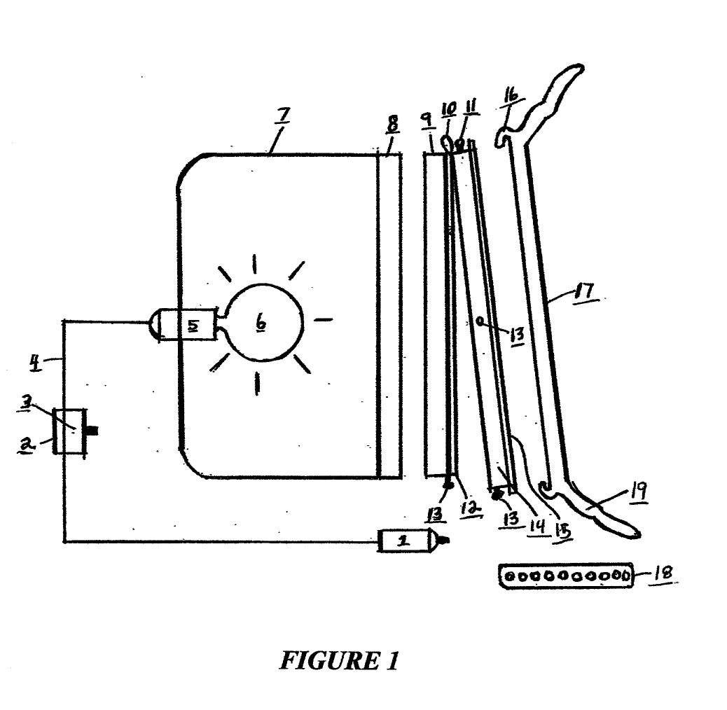

FIG. 1 is a detailed cut-away of the entire assembly, showing the (7) plastic molded light casing with the internal reflective material, and (8) the inside grooved ‘male’ sleeve which slides into the (9) outside grooved ‘female’ sleeve. The (9) female outside sleeve attachment is attached to the (14) suction cup frame by a (10) plastic hinge. The (9) Female sleeve, (10) hinge, and (14) suction cup frame are all one continuous molded piece of stronger, harder, more durable plastic. (12) An above fed internal slot is for the insertion of translucent information disks, which are held in place by gravity.

(15) The ridge on the suction cup frame is for mounting the suction cup, and runs the entire outer circumference of the suction cup frame; as does the (16) ‘C’ shaped counter ridge on the suction cup run an entire circle, demarking the center ‘face’ from the outer ‘lip,’ and is the same circumference as the suction cup frame. The (16) ‘C’ shaped counter ridge on the suction cup is stretched up and over the (15) ridge onto the (14) suction cup frame, thus locking it into place. (17) Is the face of the suction cup, and (19) is the lip of the suction cup; which is thicker at the base and thinner at the edge. The (19) lip is also convex on the distal outside edge and concave on the inside proximal edge for maximum suction capability.

(18) Is a lightweight flat snap-on plastic support rod used for stabilization between the housing/sleeve and the frame/suction cup, after adjustment is made for attachment to an aerodynamic automobile rear window. (13) Is the snap-on buttons at the floor of the apparatus for connection with the plastic support rod. (11) Is the snap-on button at the ceiling of the apparatus for the attachment of the wrap around sock, to begin and end at snap-on button (11), having circumnavigated the entire circumference of the suction cup frame, and having snapped onto other buttons (13) on the suction cup frame and at 90-degree angles of same.

(6) Is the light bulb that is screwed into (5) the light bulb socket, which is attached to (4) the power cord, which is attached to (3) the on/off switch with the (2) sticky tape and/or screw on attachment, finally ending at (1) the power source, being either a cigarette lighter or hot wire.

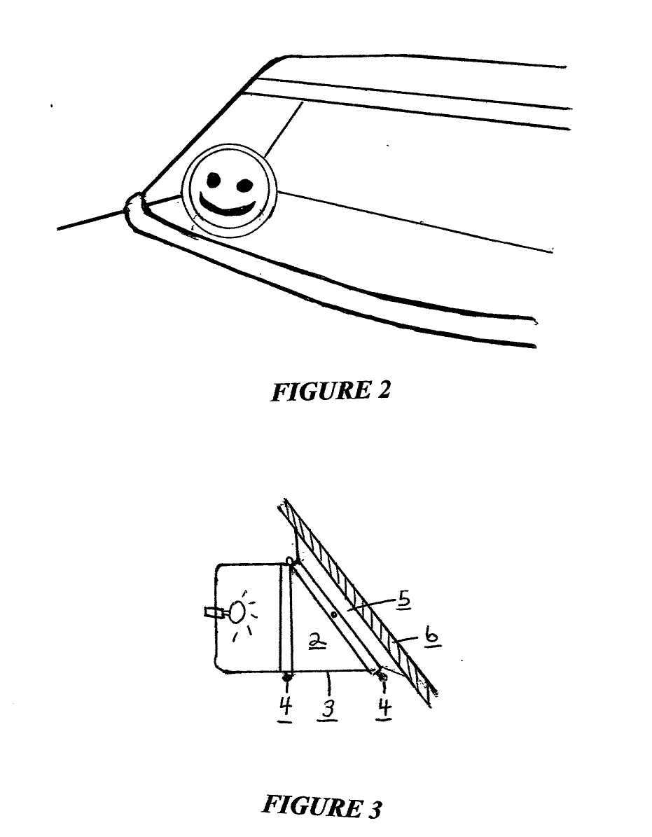

FIG. 2 The Invention, an illuminated message display apparatus, being circular in design is shown here as it may appear to a pedestrian, or driver behind the designated automobile.

FIG. 3 shows exactly how the apparatus would look in an adjusted state when attached to an aerodynamic rear window. Said face of cylindrical housing is plumbed to a 90-degree vertical angle and locked in place by (3) the support brace which is snapped onto (4) snap on fastener buttons. (2) The sock is shown in place, having been rapped around the gap created between the sleeve and frame, which was formed when the adjustment was made. (5) The suction cup is attached to (6) the window glass.

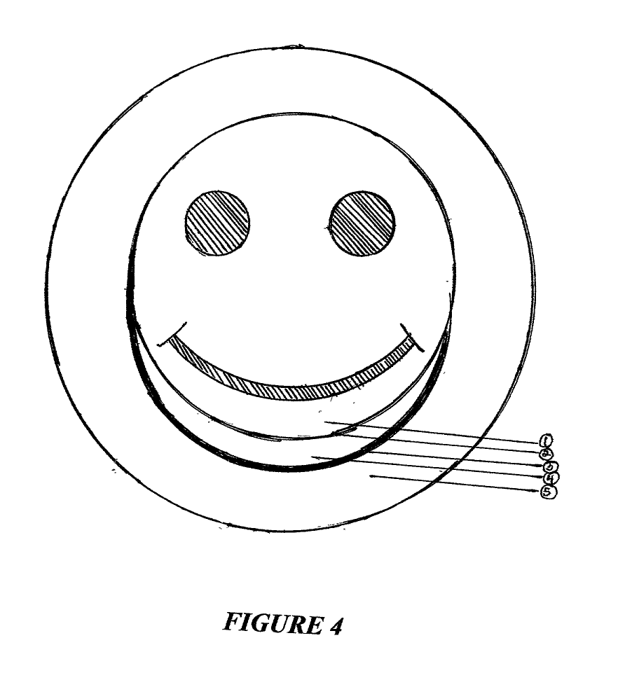

FIG. 4 is the front view of the assembly, with (1) being the translucent illuminated message display, (2) being the edge of the display. (4) Is the area that is the difference between the oval shape of the outside suction cup frame and the inside circular illuminated message display. (3) Is the suction cup frame and (5) is the lip of the suction cup.

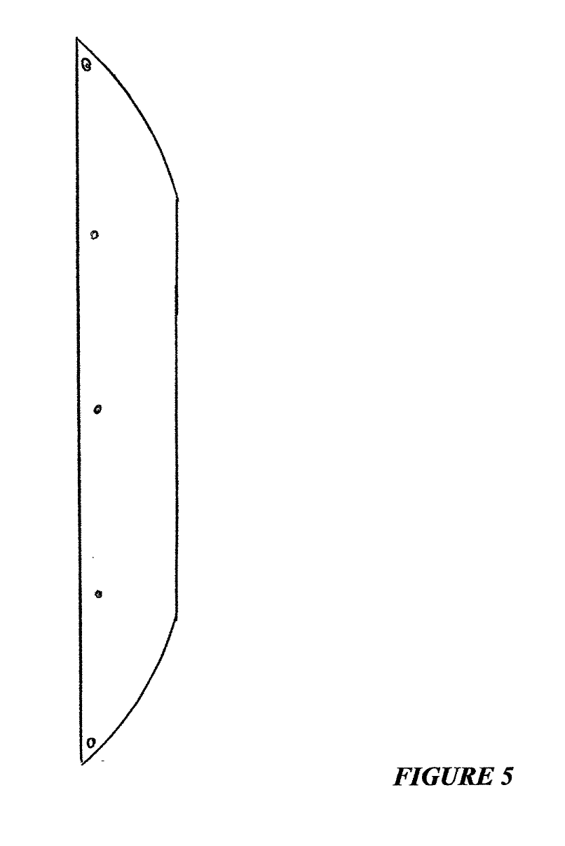

FIG. 5 is simply the sock that raps around the adjusted assembly when it is used in conjunction with a slanted aerodynamic automobile rear window.

1. An illuminated message display apparatus for an automobile window, and adaptable for any window display, comprising:
(A) An extremely lightweight “molded plastic” assembly comprised of a cylindrical housing; said housing has a closed distal wall consisting of a centered light socket and small light bulb, interior reflective paint or reflective material, and an open ridged proximal sleeve.
(B) The forward male-ridged sleeve accepts a snug slide on female-ridged sleeve of slightly thicker and thus stronger plastic, locking both together. Said female-ridged sleeve having an above loading slot for translucent art disks, and a ceiling hinge connecting the female-ridged sleeve and housing to a slightly larger, vertically oval shaped suction cup frame.
(C) The vertically oval shaped suction cup frame having a ridge spanning the outer proximal circumference for the application of a large transparent suction cup.
(D) The large transparent suction cup frames the entire face of the housing, and allows for easy and instantaneous attachment to the interior automobile window surface.

2. The light socket, of 1.(A), having an elongated power cord.
(A) Said power cord extending a substantial length to accommodate attachment to an automobile dashboard of a two-stage push button on/off switch.
(a) The push button on/off switch mounted by a double sided sticky tape, or screws.
(b) The push button on/off switch having a two-stage capability; comprising of a light pressured non-locking flash on, and a heavier pressured locking continuous on.
(B) Said power cord then extending from the push button two stage on/off switch to terminate at the power source:
(a) Said termination being a 12 volt cigarette lighter adaptor for engagement with an automobile lighter socket; or
(b) Said termination being a 12 volt hot wire leading into the automobile fuse box; or
(c) Said termination being a 120 volt wall socket.

3. Said translucent art disk, of 1(B), having either a written message, religious symbol, athletic insignia, school mascot, business logo, or a plethora of individual art work.

4. Said hinge, of 1.(B), being hinged between the circular female ridged sleeve and the vertically oval suction cup frame being thus to accommodate the horizontal aiming of the cylindrical housing when mounted on a sloping aerodynamic automobile back window.

5. Said vertically oval frame, of 1.(B) & 1.(C), being vertically oval to accommodate lost area viewing space which occurs when the cylindrical housing is mounted to point horizontally and the suction cup frame is mounted on a sloping aerodynamic automobile back window.

6. Said female slotted sleeve, of 1.(B), and the vertically oval suction cup frame, of 1.(B) & 1.(C), having mail snap on buttons aligned at the vertically lower most edge to accommodate a stabilizing lightweight flat plastic snap on support rod lined with a series of holes to allow for multiple adjustments for snap on assembly.

7. Said adjustment of female-ridged sleeve, of 1.(B), and vertically oval suction cup frame, of 1.(B) & 1.(C), for horizontal viewing and attachment to a sloping aerodynamic automobile rear window creating a wedged gap between same, thus needing an adjustable sock to wrap around the outer circumference of the gap, impeding light from escaping into the cab of the automobile.
(A) Said suction cup frame having male snap on buttons aligned at the true ceiling, and floor and 90% angles to same for attachment of sock.
(B) Said sock to be of a thin, opaque flat plastic strip, which can circumnavigate the entire circumference of the apparatus at the location of the gap.
(C) Said sock having one edge to be straight, and lined with holes to accommodate snap on fittings to the suction cup frame, beginning and culminating at the vertical ceiling, and adjacent to the hinge.
(D) Said sock having opposing edge of strip being curved in nature, to accommodate said gap, with ends being tapered for fitting at the vertical ceiling, and wide in the center to accommodate the gap at the vertical floor.

8. Said transparent suction cup, of 1.(C) & 1.(D), Comprised of a polymeric material as rubber or rubber modified plastic, and being larger than the circumference of the entire cylindrical housing, sleeve, and ridged frame:
(A) Said transparent suction cup being flat and smooth in nature when spanning the face of said housing and suction cup frame, so as to create an air tight membrane, or window, for the translucent art disk to radiate through, and
B) Said transparent suction cup having a large oval lip around the outer circumference of suction cup frame, being thick at the base of the frame and thinning out as it reaches the outer most edge; and said oval lip being concave on the proximal adhesive side and likewise, convex on the distal non adhesive side.
(C) Said transparent suction cup having a small “C” shaped ridge, in between the suction cup face and the suction cup lips, in the shape of an oval and mirroring the ridge on the suction cup frame and being on the distal portion of the suction cup, being used for stretching over the ridged area of the suction cup frame, with the ridge on the frame being the catalyst for cohesion of the suction cup to the housing.

9. Said female-ridged sleeve of 1.(B) can be modified to provide a non-adjustable device, in so doing the female-ridged sleeve would not have the ceiling hinge for connection to the suction cup frame; but would have a ridged spanning the outer proximal circumference for the direct application of a circular suction cup.
